(19) United States
(12) Patent Application Publication
(10) Pub. No.: US 2026/0140847 A1
(43) Pub. Date: May 21, 2026

(54) WORK SUPPORT SYSTEM, WORK SUPPORT METHOD, AND INFORMATION STORAGE MEDIUM

(71) Applicant: Cybozu, Inc., Tokyo (JP)

(72) Inventors: Masaki TAKAHASHI, Setouchi-shi (JP); Shogo NINOMIYA, Ichikawa-shi (JP)

(21) Appl. No.: 19/390,663

(22) Filed: Nov. 16, 2025

(30) Foreign Application Priority Data
Nov. 18, 2024 (JP) 2024-200675

(51) Int. Cl. G06F 11/3604; G06Q 10/0635

(52) U.S. Cl. CPC G06F 11/3604; G06Q 10/0635

(57) ABSTRACT

Provided is a work support system including at least one processor configured to: acquire function information relating to a work support function, which supports work, and is created by a user; acquire rule information relating to a rule for the work support function; cause an artificial intelligence (AI) to estimate whether the work support function complies with the rule based on the function information and the rule information; and output an estimation result obtained by the AI.

### CROSS-REFERENCE TO RELATED APPLICATION

The present disclosure contains subject matter related to that disclosed in Japanese Patent Application JP 2024-200675 filed in the Japan Patent Office on November 18, 2024, the entire contents of which are hereby incorporated by reference.

### BACKGROUND OF THE INVENTION

Field of the Invention

The present disclosure relates to a work support system, a work support method, and an information storage medium.

### 2. Description of the Related Art

Hitherto, there have been known work support functions that support work. For example, in Japanese Patent Application Laid-open No. 2024-013784, there is described a source code correction support device that searches, based on a rule list with priorities assigned to rules for writing source code that is an example of the work support functions, for violation descriptions that violate the rules in the source code, and determines a corrective policy for the violation descriptions based on the priorities assigned to the rules violated by the violation descriptions.

### SUMMARY OF THE INVENTION

However, the source code correction support device as described in Japanese Patent Application Laid-open No. 2024-013784 can only determine compliance based on a simple comparison between a rule defining a violation description and source code, and thus may fail to appropriately determine whether or not a work support function complies with a rule. This issue also arises in other work support functions other than the source code as described in Japanese Patent Application Laid-open No. 2024-013784. Accordingly, it is required to appropriately determine whether or not a work support function complies with a rule.

One object of the present disclosure is to appropriately determine whether or not a work support function complies with a rule.

According to at least one aspect of the present disclosure, there is provided a work support system including at least one processor configured to: acquire function information relating to a work support function, which supports work, and is created by a user; acquire rule information relating to a rule for the work support function; cause an artificial intelligence (AI) to estimate whether the work support function complies with the rule based on the function information and the rule information; and output an estimation result obtained by the AI.

### BRIEF DESCRIPTION OF THE DRAWINGS

FIG. 1 is a diagram for illustrating an example of a hardware configuration of a work support system.

FIG. 2 is a view for illustrating an example of screens displayed on a user terminal.

FIG. 3 is a view for illustrating an example of screens displayed on the user terminal.

FIG. 4 is a diagram for illustrating an example of functions implemented in the work support system.

FIG. 5 is a diagram for illustrating an example of AI inputs and an AI output.

FIG. 6 is a view for illustrating an example of how an estimation result is output.

FIG. 7 is a flowchart for illustrating an example of processing executed in the work support system.

FIG. 8 is a diagram for illustrating an example of functions implemented in a work support system according to modification examples.

FIG. 9 is a diagram for illustrating an example of AI inputs and an AI output in Modification Example 1.

FIG. 10 is a diagram for illustrating an example of AI inputs and an AI output in Modification Example 3.

FIG. 11 is a diagram for illustrating an example of AI inputs and an AI output in Modification Example 4.

FIG. 12 is a diagram for illustrating an example of inputs to and an output from an AI or another AI that generates rule information in Modification Example 5.

### DESCRIPTION OF THE EMBODIMENTS

### Hardware Configuration

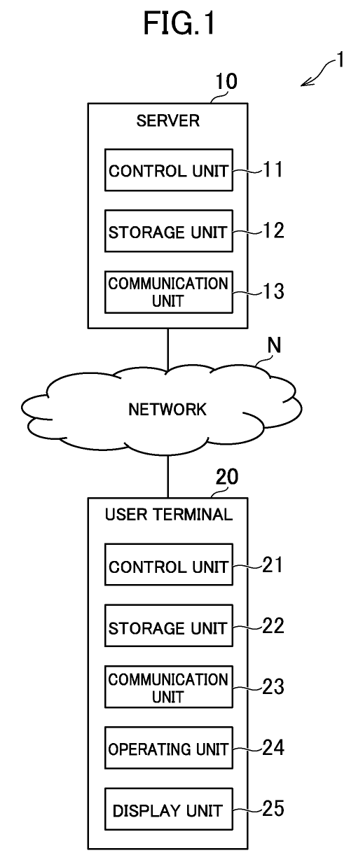

An example of a work support system, a work support method, and a program according to at least one embodiment of the present disclosure is described. FIG. 1 is a diagram for illustrating an example of a hardware configuration of the work support system. For example, a work support system 1 includes a server 10 and a user terminal 20. The server 10 and the user terminal 20 are each connected to a network N such as the Internet or a LAN.

The server 10 is a server computer. For example, the server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The user terminal 20 is a computer of a user. For example, the user terminal 20 is a personal computer, a tablet computer, or a smartphone. The user terminal 20 includes a control unit 21, a storage unit 22, a communication unit 23, an operating unit 24, and a display unit 25. Hardware configurations of the control unit 21, the storage unit 22, and the communication unit 23 may be the same as those of the control unit 11, the storage unit 12, and the communication unit 13, respectively. The operating unit 24 is an input device such as a mouse or a touch panel. The display unit 25 is a liquid crystal display or an organic EL display.

Programs stored in the storage units 12 and 22 may be supplied via the network N. A hardware configuration of each of the server 10 and the user terminal 20 is not limited to the example of FIG. 1. For example, each of the server 10 and the user terminal 20 may include at least one of a reading unit (for example, a memory card slot) that reads a computer-readable information storage medium or an input/output unit (for example, a USB terminal) for directly connecting to an external device. A program stored in the information storage medium may be supplied to each one of the server 10 and the user terminal 20 through at least one of the reading unit or the input/output unit.

Moreover, the work support system 1 is only required to include at least one computer. The computers included in the work support system 1 are not limited to the example of FIG. 1. For example, the work support system 1 may include only the server 10. In this case, the user terminal 20 is present outside the work support system 1. The work support system 1 may include the server 10 and another server computer. The work support system 1 may include only the user terminal 20. In this case, the server 10 is present outside the work support system 1.

### Overview of Work Support System

In the at least one embodiment, the work support system 1 provides a work support service to users. The work support service is a service that supports work. A service called groupware is one example of the work support service. The work support service may be a cloud-based service or an on-premises service. For example, an organization such as a company to which users belong contracts with the work support service. As a member of the organization, each user uses the work support service. Each user may use the work support service as an individual instead of as a member of the organization. At least one work support function is prepared in the work support service.

The work support function is a function that supports work. The work support function can also be said to be at least one of a program that indicates a series of information processing steps for supporting work or data to be referred to by the program. The work support function may be a function similar to that of a publicly-known work support service. For example, the work support function may be a data management function of managing data, a schedule function of managing schedules, a communication function of supporting communication between users, an email management function of managing emails, a workflow function of implementing a workflow, or another function.

In the at least one embodiment, the data management function is described as an example of the work support function. Further, a type of database called an app is described as an example of the data management function. The term "app" is generally an abbreviation for application, which is a type of program, but in the at least one embodiment, the app is a type of data management function. The app is a complex work support function that has not only the data management function but also another function such as the communication function. Various kinds of data relating to work are registered in the app. A user may communicate with another user by registering a comment in a record of the app.

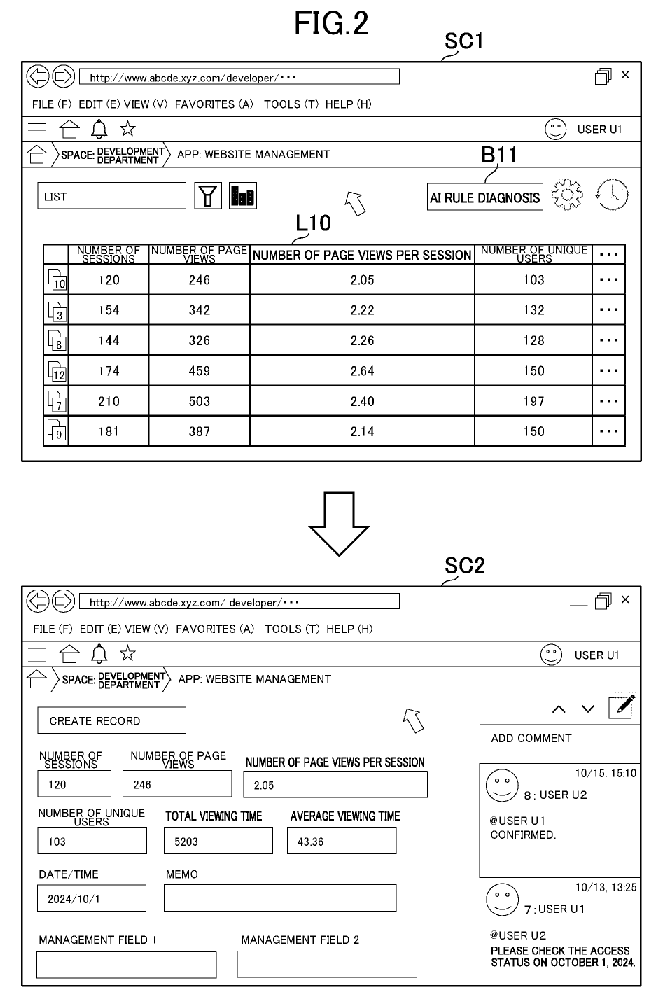

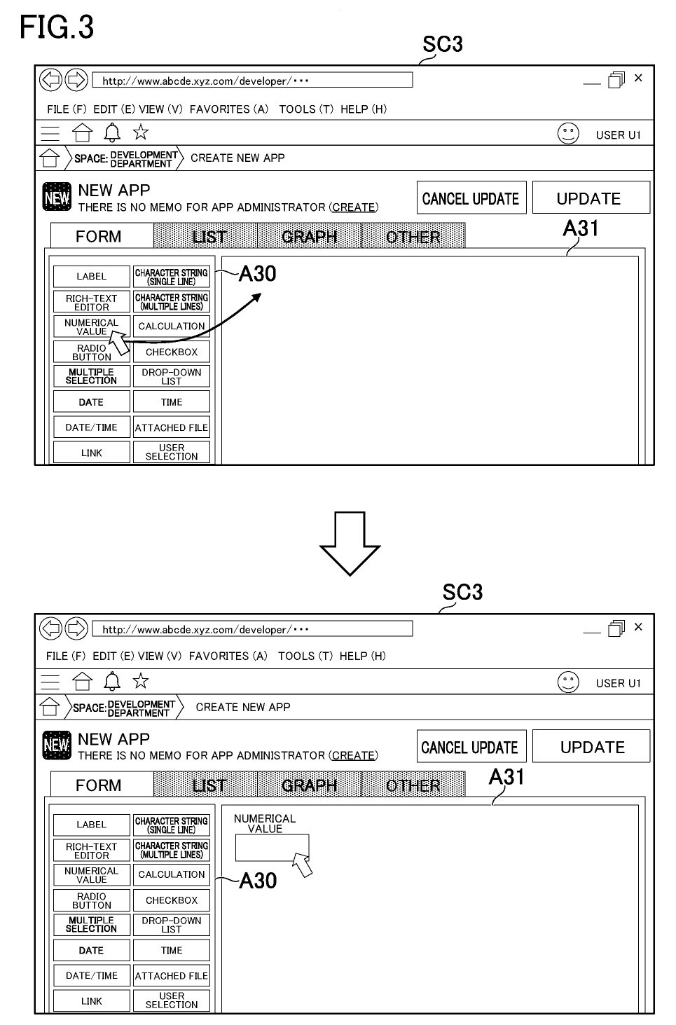

FIG. 2 and FIG. 3 are views for illustrating examples of screens displayed on the user terminal 20. For example, when the user logs in to the work support service and selects the app, the user terminal 20 displays a record list screen SC1 including a list L10 of records of the app on the display unit 25 as in the upper half of FIG. 2. In the example in the upper half of FIG. 2, an app for the user to manage a website is indicated. The app may be used for any purpose. The app may be used for another purpose other than the management of a website.

For example, the first line of the list L10 indicates field names, which are names of fields. Each line from the second line onward of the list L10 indicates specific content of a record. When the user selects a record from the list L10, the user terminal 20 displays, on the display unit 25, a record detail screen SC2 showing details of the record selected by the user, as in the lower half of FIG. 2. The record detail screen SC2 includes an input form for receiving input of the specific content of the record. The user can also register a comment in the record from the record detail screen SC2.

In the at least one embodiment, a case in which the user can create an app with no-code or low-code is taken as an example. For example, when the user performs an operation to create a new app in the work support service, the user terminal 20 displays, on the display unit 25, an app creation screen SC3 for the user to create a new app, as in the upper half of FIG. 3. The user may create a new app by editing an app prepared in advance. The user may also create a new app by copying and editing an already-created app.

For example, the user designates a setting of the app from the app creation screen SC3. In the example in the upper half of FIG. 3, the user designates the input form on the record detail screen SC2 as the setting of the app. Parts representing input formats such as a numerical value and a character string are arranged in a display area A30. As in the upper half and the lower half of FIG. 3, the user can designate the input form on the record detail screen SC2 by dragging and dropping parts from the display area A30 to a display area A31. The user can designate the field names of the fields corresponding to the input form from the display area A31.

The setting of the app that can be designated by the user is not limited to the input form. The user can designate any setting from the app creation screen SC3. For example, the user may be able to designate an app name which is a name of the app, a memo for explaining the app, a field code which is a code for identifying the field, an expression set in the field, a display format of the record list screen SC1, a format of a graph displayed in the app, an access right, an extension (for example, a script or a plug-in) of the app, or another setting. The setting that can be designated by the user may be similar to a publicly-known setting.

In the at least one embodiment, the user can easily create an app for any purpose. Meanwhile, when the user freely creates an app, there is a possibility that an app that is not intended by the organization (for example, an app that lacks consistency across the organization) may be created. This point also applies to another work support function other than the app. In view of this, the work support system 1 is configured to appropriately estimate whether or not the work support function created by the user complies with a predetermined rule. Details of the work support system 1 are described below.

### Functions implemented in Work Support System

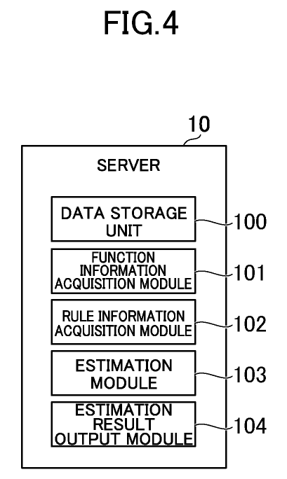

FIG. 4 is a diagram for illustrating an example of functions implemented in the work support system 1. In FIG. 4, functions implemented in the server 10 among the functions implemented in the work support system 1 are illustrated. For example, the server 10 includes a data storage unit 100, a function information acquisition module 101, a rule information acquisition module 102, an estimation module 103, and an estimation result output module 104. The data storage unit 100 is implemented by the storage unit 12. Each of the function information acquisition module 101, the rule information acquisition module 102, the estimation module 103, and the estimation result output module 104 is implemented by the control unit 11.

### Data Storage Unit

The data storage unit 100 stores various kinds of data in the work support service. In the at least one embodiment, a case in which the data storage unit 100 includes a storage area for each of a plurality of tenants (for example, organizations, non-organizational groups, or individuals) that use the work support service is taken as an example. That is, a case in which the storage area of the data storage unit 100 is divided into an area for each tenant is taken as an example. The storage area for a certain tenant stores the data of the certain tenant. The tenant can also be said to be a contractor of the work support service.

The storage area of the data storage unit 100 is not required to be divided into an area for each tenant. In this case, respective pieces of data of the plurality of tenants may be stored in the same storage area. The respective pieces of data of the plurality of tenants may be compiled in a common database stored in the data storage unit 100. A management method for the data of each tenant is not limited to the example of the at least one embodiment. The management method for the data of each tenant may be similar to that of a publicly-known work support service.

For example, the storage area for a certain tenant stores rule information on the certain tenant and function information on a work support function created by the certain tenant. Details of the rule information and the function information are described later. The storage area for a certain tenant may store other data such as actual data of the work support function, a tenant database in which various kinds of information relating to the certain tenant are stored, a user database in which various kinds of information on users belonging to the certain tenant are stored, or another database.

The data stored in the data storage unit 100 is not limited to the above-mentioned examples. The data storage unit 100 can store any data. For example, the data storage unit 100 may store data required for displaying each screen such as the record list screen SC1, the record detail screen SC2, and the app creation screen SC3. The data storage unit 100 may store default data of the work support function, which is exemplified by the app. When the work support function is created with no-code or low-code, the app is created based on the default data. The data storage unit 100 may also store a default prompt described later.

### Function Information Acquisition Module

The function information acquisition module 101 acquires function information relating to a work support function, which supports work, and is created by the user. The user creating a work support function refers to the user designating a setting of the work support function. In the example of FIG. 3, the user performing various operations on the app creation screen SC3 corresponds to the user creating a work support function. For example, when the user of a certain tenant creates a work support function, the storage area for the certain tenant in the data storage unit 100 stores various kinds of information (for example, the function information) on the created work support function.

In the at least one embodiment, the function information acquisition module 101 acquires, as the function information, function setting information relating to a setting, which relates to the work support function, and is designated by the user. The function setting information indicates specific setting content in the work support function. For example, the function setting information may be a setting relating to display of a screen of the work support function, a setting relating to a program included in the work support function, or a setting relating to data included in the work support function. In the example of FIG. 3, the function setting information indicates the setting content designated by the user from the app creation screen SC3. In the at least one embodiment, a case in which the function setting information is text (a character string) written in a natural language is taken as an example, but the function setting information may be in another format (for example, a list of numerical values, an image, or program code) other than the text.

The function setting information may be any setting that can be designated in a publicly-known work support function. For example, when the work support function is the app, the function setting information indicates the setting of the app designated by the user. The function setting information may be a layout of the input form, the app name, the memo for explaining the app, the field name, the field code, the expression set in the field, the display format of the record list screen SC1, the format of the graph, security, the access right, an administrator of the app, the extension (for example, the script or the plug-in) of the app, or another setting.

For example, when the work support function is another data management function other than the app, the function setting information may indicate a setting of a screen of another data management function, a setting of the access right, a setting of a format of a file that can be uploaded, or another setting. When the work support function is the schedule function, the function setting information may indicate a setting of the screen of the schedule function, a setting of a facility that can be registered in a schedule, a setting of the user for whom the schedule is to be managed, or another setting. When the work support function is the communication function, the function setting information may indicate the setting of the screen of a communication tool such as conversation threading or online chat, the setting of the access right for a post, or another setting.

In the at least one embodiment, the function setting information is stored in the data storage unit 100, and hence the function information acquisition module 101 acquires the function setting information from the data storage unit 100. For example, the function information acquisition module 101 acquires, from the data storage unit 100, the function setting information on the work support function to be estimated by the estimation module 103. When the work support function of a certain tenant is to be estimated, the function information acquisition module 101 acquires, from the data storage unit 100, the function setting information on the work support function from the storage area for the certain tenant. When the function setting information is stored in another computer other than the server 10 or an information storage medium, the function information acquisition module 101 may acquire the function setting information from the another computer or the information storage medium.

The function information is not limited to the function setting information. The function information may be any information relating to the work support function. Other examples of the function information are described later in modification examples. The function information is information representing a higher-level concept that encompasses the function setting information described in the at least one embodiment and other examples described in the modification examples. The function information may be information of a screenshot of the work support function, or may be display data of the screen of the work support function (for example, HTML data of the record list screen SC1 or the record detail screen SC2). The function information may be information representing a higher-level concept that encompasses those examples. The "function setting information" as used in the at least one embodiment can be replaced as any other type of function information.

### Rule Information Acquisition Module

The rule information acquisition module 102 acquires rule information relating to a rule for the work support function. The rule is a rule relating to the creation of the work support function. The rule can also be said to be governance or a policy. The rule may be a rule of how to use the work support function, a rule for data to be registered in the work support function, a rule for the setting of the work support function, or another rule. In the at least one embodiment, a case in which a rule is defined for each tenant is taken as an example, but a rule common to a plurality of tenants may also be defined, or a rule may also be defined for each group (for example, each department or each team) within a certain tenant.

In the at least one embodiment, the rule information acquisition module 102 acquires, as the rule information, setting rule information relating to a rule for the setting. The setting rule information indicates specific content of the rule for the setting. The setting rule information may be a rule for the setting relating to the display of the screen of the work support function, a rule for the setting relating to the program included in the work support function, or a rule for the setting relating to the data included in the work support function. In the example of FIG. 3, the setting rule information indicates a rule for the setting content that can be designated by the user from the app creation screen SC3. In the at least one embodiment, a case in which the setting rule information is text (a character string) written in a natural language is taken as an example, but the setting rule information may be in another format (for example, a list of numerical values, an image, or program code) other than the text.

The setting rule information may be a rule in any setting that can be designated in a publicly-known work support function. For example, when the work support function is the app, the setting rule information indicates a rule for the setting of the app designated by the user. The setting rule information may be a rule for the layout of the input form on the record detail screen SC2, a rule for a description format of the app name, a rule for a description format of the memo for explaining the app, a rule for a description format of the field name, a rule for a description format of the field code, a rule for a description format of the expression set in the field, a rule for the display format of the record list screen SC1, a rule for the format of the graph, a rule for a setting of the security, a rule for the setting of the access right, a rule for the administrator of the app, a rule for the extension (for example, the script or the plug-in) of the app, a rule for managing personal information or confidential information, a rule for consistency with another work support function, a rule for correlation with another work support function, or another rule.

For example, when the work support function is another data management function other than the app, the setting rule information may indicate a rule for the setting of the screen of the another data management function, a rule for the setting of the access right, a rule for the setting of the format of the file that can be uploaded, or a rule for the another setting. When the work support function is the schedule function, the setting rule information may indicate a rule for the setting of the screen of the schedule function, a rule for the setting of the facility that can be registered in the schedule, a rule for the setting of the user for whom the schedule is to be managed, or a rule for another setting. When the work support function is the communication function, the setting rule information may indicate a rule for the setting of the screen of the communication tool such as the conversation threading or the online chat, a rule for specific content of the post, or a rule for another setting.

In the at least one embodiment, the setting rule information is stored in the data storage unit 100, and hence the rule information acquisition module 102 acquires the setting rule information from the data storage unit 100. The rule information acquisition module 102 acquires, from the data storage unit 100, the setting rule information indicating a rule applied to the work support function to be estimated by the estimation module 103. When the setting rule information is stored in another computer other than the server 10 or an information storage medium, the rule information acquisition module 102 may acquire the setting rule information from the another computer or the information storage medium. For example, an administrator who manages rules for the tenant may operate his or her own user terminal 20 to register the setting rule information in the data storage unit 100, another computer, or an information storage medium.

The rule information is not limited to the setting rule information. The rule information may be any information relating to the rule for the work support function. Other examples of the rule information are described later in the modification examples. The rule information is information representing a higher-level concept that encompasses the setting rule information described in the at least one embodiment and other examples described in the modification examples. The rule information may be other information such as that of an environment of the user terminal 20 that uses the work support function. The rule information may be information representing a higher-level concept that encompasses those examples. The "setting rule information" as used in the at least one embodiment can be replaced as any other type of rule information. For example, the rule information may indicate a rule for consistency between one work support function and another work support function. The rule information may be consistency of the field serving as a header of each record, such as a subject or a title of the app, or consistency of the layout including a label assignment method or placement.

### Estimation Module

The estimation module 103 causes an artificial intelligence (AI) to estimate whether or not the work support function complies with the rule based on the function information and the rule information. The work support function complying with the rule refers to the work support function being created in accordance with the rule. In other words, the work support function complying with the rule refers to the work support function satisfying the rule.

In the at least one embodiment, the function setting information is acquired as the function information, and the setting rule information is acquired as the rule information. Thus, the estimation module 103 causes the AI to estimate whether or not a setting relating to the work support function complies with the rule based on the function setting information and the setting rule information. The setting complying with the rule refers to the setting being created in accordance with the rule. In other words, the setting complying with the rule refers to the setting satisfying the rule.

The AI is a program capable of generating an electronic product based on input information that is information input to the AI. The AI may also be called a generative AI. There are various views in terms of definitions of the AI, but the AI in the at least one embodiment may be an AI in any one of various publicly-known definitions. The AI in the at least one embodiment includes various AIs recognized as AIs by a person skilled in the art at the time of filing. For example, the generative AI may not only be an AI developed by a machine learning method but also an AI developed by another method other than the machine learning. In the at least one embodiment, a case in which the AI is managed by an external system that is an externally provided system that cooperates with the work support system 1 is taken as an example, but the work support system 1 may manage the AI. That is, the data storage unit 100 may store actual data of the AI.

For example, the AI may be a large language model, a machine learning model not classified as a large language model (a model trained by using a machine learning method, for example, a model such as generative adversarial networks (GAN) or variational autoencoders (VAE)), or another model. In the at least one embodiment, a case in which a pre-trained large language model corresponds to the AI is taken as an example. The large language model may be of any type. For example, the large language model may be a transformer-based model such as a generative pre-trained transformer (GPT) or bidirectional encoder representations from transformers (BERT), or another model not classified as a transformer (for example, a neural network).

For example, the AI includes a program that indicates a series of processes from when the input information is input until output is performed, and parameters to be referred to by the program. The parameters may be incorporated into a part of an AI program. The parameters of the AI may be similar to publicly-known parameters. For example, the parameters of the AI may be weights and biases. The AI may include other information other than the program and the parameters. The AI may be a single-modal type AI that can process only the input information in a specific format, or may be a multi-modal type AI that can process the input information in a plurality of formats.

For example, the AI may include an input layer that processes the input information, an intermediate layer that calculates an embedded representation of the input information based on the parameters, and an output layer that performs output corresponding to the embedded representation. The embedded representation is information for the AI to recognize the input information. The embedded representation may also be called a feature amount or a feature vector. The embedded representation may be a multidimensional vector, or may be in another form (for example, an array, a matrix, a single numerical value, or a plurality of numerical values). The input information may be divided into units called tokens. The AI may calculate embedded representations for individual tokens. The AI may predict the continuation of the input information based on a sequential order of the embedded representations of the individual tokens.

In the at least one embodiment, the AI is assumed to have already learned various kinds of training data for training. When a model capable of natural language processing, which is exemplified by the large language model, corresponds to the AI, the AI is assumed to have already learned various kinds of text for training as the training data. The parameters of the AI have been adjusted by learning the training data. A general-purpose AI that has been subjected to pre-training may be used as it is, or an AI that has been fine-tuned for the work support system 1 may be used. The learning method for the AI may be similar to a publicly-known machine learning method. As with the definitions of the AI, there are various views in terms of definitions of the machine learning, but the machine learning in the at least one embodiment includes various publicly-known definitions. For example, deep learning is also included in the machine learning.

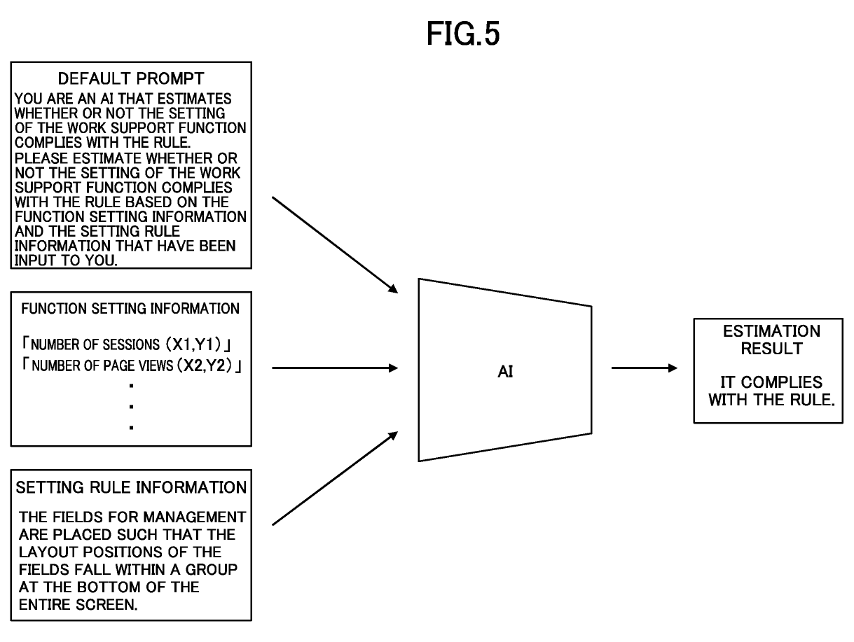

FIG. 5 is a diagram for illustrating an example of AI inputs and an AI output. In the at least one embodiment, a case in which the AI is managed by an external system is taken as an example, and hence the AI input can also be said to be information that is transmitted to the external system by the server 10. The AI output can also be said to be information that is received from the external system by the server 10. In the at least one embodiment, the AI output is an estimation result as to whether or not the work support function complies with the rule. In the example of FIG. 5, a case in which the estimation result is text (a character string) in a natural language is taken as an example, but the estimation result may be in another format (for example, a single numerical value, a plurality of numerical values, an image, or program code) other than the text.

For example, a default prompt, which is a prompt prepared in advance by default, may be input to the AI. The prompt is an instruction to the AI. In the at least one embodiment, a case in which text written in a natural language corresponds to the prompt is taken as an example, but the prompt may also be text written in another language (for example, a programming language or a database language) other than the natural language. The prompt may also be in another format (for example, a document format, an image format, or a table format) other than the text.

In the at least one embodiment, the default prompt is assumed to be stored in the data storage unit 100. The default prompt may be stored in another computer other than the server 10 or an information storage medium. The estimation module 103 may acquire the default prompt from the data storage unit 100, the another computer, or the information storage medium. A prompt input by the user may be input to the AI. Both the prompt input by the user and the default prompt may be input to the AI.

For example, the default prompt indicates processing content to be executed by the AI. In the at least one embodiment, a case in which a general-purpose AI that is not specialized for a specific task is used is taken as an example. Thus, the default prompt indicates a task of the AI. The task is content of processing to be executed by the AI. The default prompt may indicate specific content to be output by the AI. The default prompt may indicate what is to be input as the input information. The default prompt may indicate a role of the AI. In the at least one embodiment, a case in which the default prompt is prepared by an administrator of the work support service is taken as an example, but the default prompt may be prepared by the user.

In the example of FIG. 5, the default prompt indicates text such as "You are an AI that estimates whether or not the setting of the work support function complies with the rule. Please estimate whether or not the setting of the work support function complies with the rule based on the function setting information and the setting rule information that have been input to you." In this default prompt, the portion "You are an AI that estimates whether or not the setting of the work support function complies with the rule." indicates the role of the AI. The next portion "Please estimate whether or not the setting of the work support function complies with the rule based on the function setting information and the setting rule information that have been input to you." indicates the specific content of the input information and the specific content to be estimated by the AI.

The default prompt may be any wording. The default prompt is not limited to the wording of FIG. 5. The default prompt may include any wording that means that the AI is to estimate whether or not the work support function complies with the rule based on the function information and the rule information. In the at least one embodiment, the case in which the function setting information is acquired as the function information and the setting rule information is acquired as the rule information is taken as an example, and hence the default prompt may include any wording that means that the AI is to estimate whether or not the setting of the work support function complies with the rule based on the function setting information and the setting rule information. The default prompt may be any one of various wordings that can be adopted by a person skilled in the art in the field of AI as a prompt required for a rule compliance estimation in the state of the art at the time of filing.

For example, as in FIG. 5, the estimation module 103 inputs the default prompt, the function setting information, and the setting rule information to the AI as the input information. The function setting information and the setting rule information may be embedded in the default prompt. In the at least one embodiment, an external system manages the AI, and hence the estimation module 103 inputs the default prompt, the function setting information, and the setting rule information to the AI by transmitting those pieces of information to the external system. When the external system acquires the default prompt, the function setting information, and the setting rule information from the server 10, the external system may input those pieces of information as the input information to the AI stored in the external system. When the actual data of the AI is stored in the data storage unit 100, the estimation module 103 may input the default prompt, the function setting information, and the setting rule information to the AI stored in the data storage unit 100 without communicating to/from an external computer.

For example, the AI calculates an embedded representation of the default prompt, the function setting information, and the setting rule information that have been input to the AI based on parameters adjusted by pre-training. The AI may divide the default prompt, the function setting information, and the setting rule information into units called tokens, and calculate an embedded representation of each token. When the AI includes a plurality of intermediate layers, the AI may repeatedly calculate the embedded representation based on each individual intermediate layer. The AI generates and outputs an estimation result corresponding to the embedded representation. When the default prompt, the function setting information, and the setting rule information are divided into tokens, the AI generates and outputs an estimation result corresponding to a sequence of the embedded representations of the individual tokens. Internal processing of the AI is not limited to the example of the at least one embodiment. The internal processing of the AI may be processing similar to that of a publicly-known AI.

In the example of FIG. 5, the AI estimates whether or not the app complies with the rule, and outputs the result as the estimation result. The estimation result indicates any one of that the app complies with the rule or that the app does not comply with the rule. For example, when the layout of the input form is indicated in the function information and the rule for the layout of the input form is indicated in the setting rule information, the AI estimates whether or not the actual layout of the input form complies with the rule, and outputs the estimation result. This series of processing steps is implemented by the calculation of the embedded representation described above. The estimation module 103 acquires the estimation result output from the AI. In the at least one embodiment, an external system manages the AI, and hence the external system transmits the estimation result to the server 10. The estimation module 103 acquires the estimation result from the external system. When the actual data of the AI is stored in the data storage unit 100, the estimation module 103 may acquire the estimation result without communicating to/from an external computer.

The AI is not required to be a general-purpose AI specialized for a specific task, and may be an AI specialized for the task of generating an estimation result as to whether or not the work support function complies with the rule. In this case, training data indicating a relationship between the function information and the rule information for training and the estimation result for training is assumed to have been learned by the AI. The learning of the training data may be executed by the server 10, or may be executed by another computer. The AI is trained so that, when the function information (for example, the function setting information) and the rule information (for example, the setting rule information) for training, which are indicated by the training data, are input to the AI, the estimation result for training, which is indicated by the training data, is output from the AI.

Further, the AI may be trained by a publicly-known learning method used in a machine learning method. For example, the training data may be learned by the AI by an error backpropagation method or a gradient descent method. When the AI is specialized for a specific task, the AI can generate an appropriate estimation result even without particularly having a prompt input thereto, and hence the estimation module 103 may input the input information to the AI without inputting a prompt to the AI. In this way, a mode in which an estimation result is generated without the input of a prompt is also within the scope of the present disclosure.

Further, the estimation module 103 may periodically cause the AI to estimate whether or not the work support function created in the work support system 1 complies with the rule. The estimation module 103 may also periodically cause the AI to estimate whether or not the work support function created by a certain tenant complies with the rule of the certain tenant. An execution interval of the estimation may be common to all tenants, or may be defined for each tenant. For example, the estimation module 103 may execute the estimation when a new setting is saved, when a setting is changed (for example, when a button for retaining a setting change is selected), when a record is updated, when the work support function such as the app is launched, when the work support function such as the app is backed up, or at another timing. The estimation module 103 may record the estimation result obtained by the AI in the data storage unit 100. For example, when the app corresponds to the work support function, the estimation module 103 may register the estimation result obtained by the AI in the app.

Further, the AI can output the estimation result in any format. The default prompt may indicate the format of the estimation result to be output by the AI. For example, the default prompt may indicate that the AI is to output the estimation result in a table format or a diagram format. The estimation module 103 may acquire the estimation result output by the AI in a table format or a diagram format. In this case, the estimation result output module 104 described later may output the estimation result in a table format or a diagram format.

### Estimation Result Output Module

The estimation result output module 104 outputs the estimation result obtained by the AI. The estimation result output module 104 outputting the estimation result to the user refers to the estimation result output module 104 transmitting data of the estimation result to the user terminal 20 or the estimation result output module 104 recording the estimation result in the storage area of the data storage unit 100 or the like. The estimation result output module 104 may transmit the estimation result directly to the user terminal 20, or may transmit thereto the estimation result indirectly through another computer. The estimation result output module 104 may output only the estimation result to the user, or may output thereto overall information including the estimation result and other information. The estimation result output module 104 can output the estimation result to any person. For example, the estimation result output module 104 may output the estimation result to the user who has created the work support function, or may output the estimation result to an administrator within the tenant.

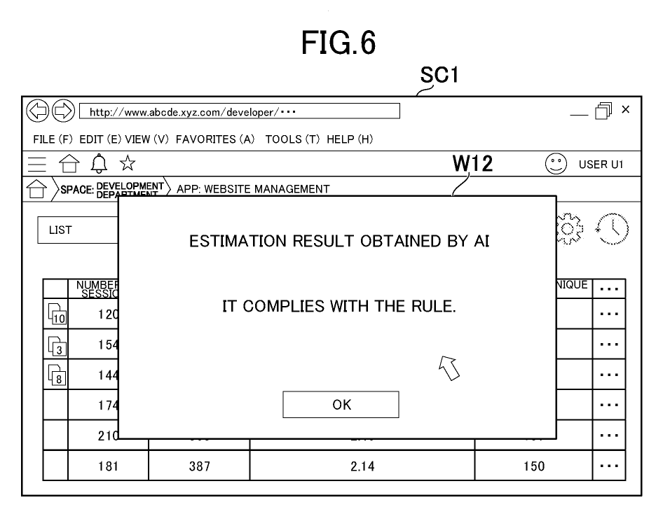

FIG. 6 is a view for illustrating an example of how the estimation result is output. In the example of FIG. 6, when the user selects a button B11 on the record list screen SC1 of a certain app, the estimation as to whether or not the certain app complies with the rule is executed. The estimation result output module 104 outputs the estimation result by displaying, on the record list screen SC1, a window W12 showing the estimation result. The estimation result output module 104 generates display data of the window W12 based on the estimation result acquired by the estimation module 103, and transmits the display data to the user terminal 20. The display data may be in any data format, for example, may be data in a markup language such as HTML or XML.

The estimation result output module 104 may output the estimation result on another screen other than the record list screen SC1. For example, the estimation result output module 104 may output the estimation result on the record detail screen SC2 or the app creation screen SC3, or may output the estimation result onto a dedicated screen for displaying whether or not the app complies with the rule. The estimation result output module 104 may output the estimation result by using email, or may output the estimation result by using a notification function in the work support service. The estimation result output module 104 may output the estimation result not to the user who has created the work support function but to another user of the tenant (for example, an administrator of the tenant). The estimation result output module 104 may output the estimation result to another person (for example, an operator of the work support service) other than the users belonging to the tenant.

Further, when the AI estimates that the work support function does not comply with the rule, the estimation result output module 104 may prompt to make a correction so as to allow the work support function to comply with the rule, together with the estimation result obtained by the AI. When the AI estimates that the work support function does not comply with the rule, the estimation result output module 104 may output a portion of the work support function that does not comply with the rule. The portion that does not comply with the rule may be estimated by the AI. For example, the default prompt may include a wording that instructs to output the portion that does not comply with the rule. The AI may output the portion that does not comply with the rule based on that wording.

### Processing executed in Work Support System

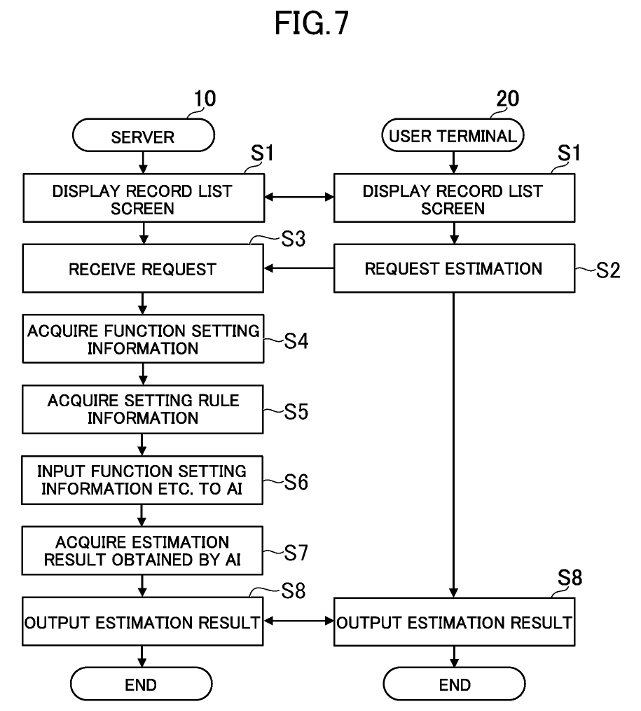

FIG. 7 is a flowchart for illustrating an example of processing executed in the work support system 1. Processing steps of FIG. 7 are executed by the control units 11 and 21 executing the programs stored in the storage units 12 and 22, respectively. The processing steps of FIG. 7 are an example of processing steps of the work support method in the at least one embodiment. In FIG. 7, processing steps relating to the output of the estimation result obtained by the AI, among the processing steps executed in the work support system 1, are illustrated.

As illustrated in FIG. 7, when the user selects any app, the server 10 executes, between the server 10 and the user terminal 20, processing for displaying the record list screen SC1 of the app selected by the user (Step S1). When the user selects the button B11, the user terminal 20 requests the server 10 to estimate whether or not the app complies with the rule (Step S2). When the request is received (Step S3), the server 10 acquires the function setting information on the app that is displayed on the record list screen SC1 from the storage area for the tenant that is an organization to which the user belongs (Step S4). The server 10 acquires, from the storage area for the tenant that is the organization to which the user belongs, the setting rule information on the tenant (Step S5).

The server 10 inputs the default prompt, the function setting information, and the setting rule information to the AI by transmitting those pieces of information to an external system (Step S6). The AI of the external system calculates the embedded representation of the default prompt, the function setting information, and the setting rule information, and outputs the estimation result corresponding to the embedded representation. The server 10 acquires, from the external system, the estimation result obtained by the AI (Step S7). The server 10 executes, between the server 10 and the user terminal 20, processing for outputting the estimation result (Step S8), and the process ends. In Step S8, as in FIG. 6, the window W12 is displayed on the record list screen SC1.

### Summary of at Least One Embodiment

The work support system 1 according to the at least one embodiment acquires the function information. The work support system 1 acquires the rule information. The work support system 1 causes the AI to estimate whether or not the work support function complies with the rule based on the function information and the rule information. The work support system 1 outputs the estimation result obtained by the AI. As a result, the work support system 1 can appropriately determine whether or not the work support function complies with the rule. For example, there is a possibility that the work support function, which is exemplified by an app that can be easily created by each of a plurality of users belonging to a certain tenant at his or her own discretion, may be created as a work support function that does not comply with the rule of the certain tenant. There is a possibility that a user who is not an engineer and does not have specialized knowledge may create a work support function that has security or operational issues. The work support system 1 can determine presence or absence of such an app. When the AI that supports natural language processing is used, an administrator who creates a rule can create a rule in a natural language instead of in a specialized language such as a markup language or a programming language, and hence the work support system 1 can reduce the burden on the administrator.

Further, the work support system 1 acquires the function setting information as the function information. The work support system 1 acquires, as the rule information, the setting rule information relating to the rule for the setting. The work support system 1 causes the AI to estimate whether or not the setting of the work support function complies with the rule based on the function setting information and the setting rule information. As a result, the work support system 1 can appropriately determine whether or not the setting of the work support function complies with the rule. For example, there is a possibility that an app for which a setting can be easily designated by each of a plurality of users belonging to a certain tenant at his or her own discretion may be created as an app having a setting that does not comply with the rule of the certain tenant. However, the work support system 1 can determine presence or absence of such an app. When the AI that supports natural language processing is used, an administrator who creates a rule for the setting can create a rule for the setting in a natural language instead of in a specialized language such as a markup language or a programming language, and hence the work support system 1 can reduce the burden on the administrator.

### Modification Examples

The present disclosure is not limited to the at least one embodiment described above. The present disclosure can be modified as required without departing from the purport of the present disclosure.

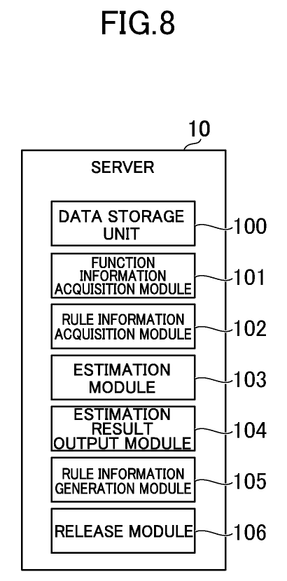

FIG. 8 is a diagram for illustrating an example of functions implemented in the work support system 1 according to the modification examples. As in FIG. 8, in the modification examples described below, the server 10 includes a rule information generation module 105 and a release module 106. Each of the rule information generation module 105 and the release module 106 is implemented by the control unit 11.

### Modification Example 1

For example, in the at least one embodiment, the case in which the function setting information corresponds to the function information has been taken as an example, but the function information is not limited to the function setting information. In Modification Example 1, another example of the function information is described. The function information acquisition module 101 in Modification Example 1 acquires, as the function information, registered-in-function information, which is information registered as actual data in the work support function. The registered-in-function information is information indicating specific content of the work of the user. For example, the registered-in-function information may be a post made by the user to the communication tool, information shared by the user with another user, a file uploaded by the user, or other information.

The registered-in-function information may be any information that can be registered in a publicly-known work support function. For example, when the work support function is the app, the registered-in-function information may be information registered in a record of the app. The registered-in-function information may be a value in each field of the record, a file uploaded to the record, or content of a comment posted to the record. The registered-in-function information may be information registered in a plug-in of the app instead of in the record of the app.

For example, when the work support function is another data management function other than the app, the registered-in-function information may be information registered in a record of the another data management function (may be data managed by the another data management function). When the work support function is the schedule function, the registered-in-function information may indicate content of a schedule registered in the schedule function, information on a facility registered in the schedule function, information on a user selectable as a schedule participant, or another setting. When the work support function is the communication function, the registered-in-function information may indicate a post registered in the communication tool such as the conversation threading or the online chat, a reaction to the post, or another setting.

In Modification Example 1, a case in which the registered-in-function information is stored in the data storage unit 100 is taken as an example. For example, when the user performs an operation to register the registered-in-function information in the work support function, the server 10 records the registered-in-function information in the data storage unit 100. In a case in which the work support function is the app, when the user performs an operation to register some information (for example, a field value, a file, or a comment) in a record of the app, the server 10 registers that information as the registered-in-function information in the data storage unit 100. Similarly for another work support function other than the app, the server 10 registers the registered-in-function information in the work support function based on an operation of the user.

For example, the function information acquisition module 101 acquires the registered-in-function information from the data storage unit 100. The function information acquisition module 101 acquires the registered-in-function information on the work support function to be estimated by the estimation module 103 from the data storage unit 100. When the work support function of a certain tenant is to be estimated, the function information acquisition module 101 acquires the registered-in-function information on the work support function from the storage area for the certain tenant from the data storage unit 100. When the registered-in-function information is stored in another computer other than the server 10 or an information storage medium, the function information acquisition module 101 may acquire the registered-in-function information from the another computer or the information storage medium.

The rule information acquisition module 102 in Modification Example 1 acquires, as the rule information, registration rule information relating to a rule for the registered-in-function information. The registration rule information indicates specific content of a rule for registering the registered-in-function information in the work support function. The registration rule information may be a rule for a data format of the registered-in-function information that can be registered in the work support function, a data size of the registered-in-function information, a rule for specific content indicated by the registered-in-function information, a rule for a user who can register the registered-in-function information, a rule for a period during which the registered-in-function information can be registered, or another rule.

The registration rule information may be a rule in any setting that can be designated in a publicly-known work support function. For example, when the work support function is the app, the registration rule information indicates a rule for the registered-in-function information registered in the app. The registration rule information may indicate a rule for the registered-in-function information registered in a record of the app. The registration rule information may be a rule for the value input to each field, a rule for the file uploaded to a record, a rule for the comment posted to the record, a rule for a user who can update the record, or another rule. The registration rule information is not required to be the rule for the record of the app, and may be a rule for the registered-in-function information registered in the extension of the app.

For example, when the work support function is another data management function other than the app, the registration rule information may indicate a rule for the registered-in-function information registered in the another data management function. When the work support function is the schedule function, the registration rule information may indicate a rule for the schedule registered in the schedule function. When the work support function is the communication function, the registration rule information may indicate a rule for the post registered in the communication tool such as the conversation threading or the online chat.

In Modification Example 1, a case in which the registration rule information is stored in the data storage unit 100 is taken as an example. For example, an administrator of a certain tenant creates registration rule information on the certain tenant, and registers the registration rule information in the data storage unit 100. The rule information acquisition module 102 acquires the registration rule information from the data storage unit 100. The rule information acquisition module 102 acquires, from the data storage unit 100, the registration rule information indicating the rule applied to the work support function to be estimated by the estimation module 103. When the registration rule information is stored in another computer other than the server 10 or an information storage medium, the rule information acquisition module 102 may acquire the registration rule information from the another computer or the information storage medium.

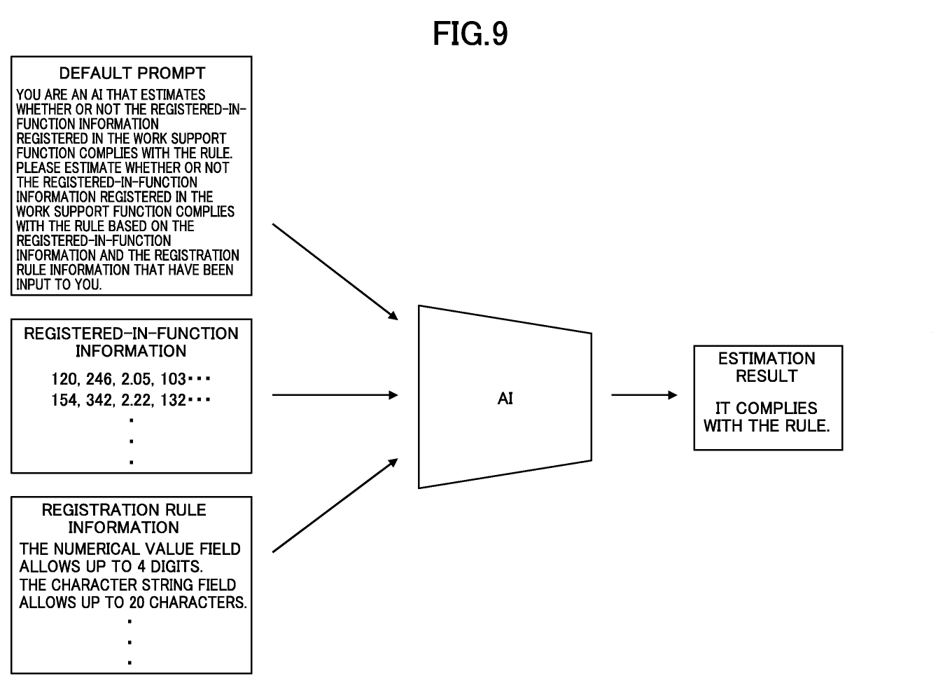

FIG. 9 is a diagram for illustrating an example of AI inputs and an AI output in Modification Example 1. The estimation module 103 in Modification Example 1 causes the AI to estimate whether or not the registered-in-function information complies with the rule based on the registered-in-function information and the registration rule information. In Modification Example 1, as in the at least one embodiment, a case in which the AI is managed by an external system is taken as an example, but the AI may be managed by the work support system 1. The default prompt in Modification Example 1 may include any wording that means that the AI is to estimate whether or not the registered-in-function information registered in the work support function complies with the rule based on the registered-in-function information and the registration rule information.

In the example of FIG. 9, the default prompt indicates text such as "You are an AI that estimates whether or not the registered-in-function information registered in the work support function complies with the rule. Please estimate whether or not the registered-in-function information registered in the work support function complies with the rule based on the registered-in-function information and the registration rule information that have been input to you." In this default prompt, the portion "You are an AI that estimates whether or not the registered-in-function information registered in the work support function complies with the rule." indicates the role of the AI. The next portion "Please estimate whether or not the registered-in-function information registered in the work support function complies with the rule based on the registered-in-function information and the registration rule information that have been input to you." indicates the specific content of the input information and the specific content to be estimated by the AI.

The default prompt may indicate that the AI is to estimate whether or not the registered-in-function information is personal information or confidential information. In this case, the registration rule information may indicate a rule for handling personal information or confidential information. The AI may, based on such a default prompt, estimate whether or not the registered-in-function information is personal information or confidential information, and estimate whether or not the handling of the personal information or the confidential information that has been registered as the registered-in-function information complies with the rule.

For example, as in FIG. 9, the estimation module 103 inputs the default prompt, the registered-in-function information, and the registration rule information to the AI as the input information. The registered-in-function information and the registration rule information may be embedded in the default prompt. In the at least one embodiment, an external system manages the AI, and hence the estimation module 103 inputs the default prompt, the registered-in-function information, and the registration rule information to the AI by transmitting those pieces of information to the external system. When the external system acquires the default prompt, the registered-in-function information, and the registration rule information from the server 10, the external system may input those pieces of information as the input information to the AI stored in the external system. When the actual data of the AI is stored in the data storage unit 100, the estimation module 103 may input the default prompt, the registered-in-function information, and the registration rule information to the AI stored in the data storage unit 100 without communicating to/from an external computer.

For example, the AI calculates an embedded representation of the default prompt, the registered-in-function information, and the registration rule information that have been input to the AI based on parameters adjusted by pre-training. The AI may divide the default prompt, the registered-in-function information, and the registration rule information into units called tokens, and calculate an embedded representation of each token. When the AI includes a plurality of intermediate layers, the AI may repeatedly calculate the embedded representation based on each individual intermediate layer. The AI generates and outputs an estimation result corresponding to the embedded representation. When the default prompt, the registered-in-function information, and the registration rule information are divided into tokens, the AI generates and outputs an estimation result corresponding to a sequence of the embedded representations of the individual tokens.

In the example of FIG. 9, the AI estimates whether or not the registered-in-function information registered in the app complies with the rule, and outputs the result as the estimation result. The estimation result indicates any one of that the registered-in-function information complies with the rule or that the registered-in-function information does not comply with the rule. When the registration rule information indicates the rule for the value in each field registered in the record, the AI estimates whether or not the actually input value complies with the rule, and outputs the estimation result. This series of processing steps is implemented by the calculation of the embedded representation described above. The estimation module 103 acquires the estimation result output from the AI. The processing in which the estimation module 103 acquires the output from the AI and the processing in which the estimation result output module 104 outputs the estimation result may be similar to those in the at least one embodiment.

The work support system 1 in Modification Example 1 acquires the registered-in-function information as the function information. The work support system 1 acquires the registration rule information as the rule information. The work support system 1 causes the AI to estimate whether or not the registered-in-function information complies with the rule based on the registered-in-function information and the registration rule information. As a result, the work support system 1 can appropriately determine whether or not the registered-in-function information registered in the work support function complies with the rule. For example, there is a possibility that an app in which the registered-in-function information can be easily registered by each of a plurality of users belonging to a certain tenant at his or her own discretion may have registered therein the registered-in-function information that does not comply with the rule of the certain tenant. However, the work support system 1 can determine presence or absence of such registered-in-function information. When the AI that supports natural language processing is used, an administrator who creates a rule for the registered-in-function information can create a rule for the registered-in-function information in a natural language instead of in a specialized language such as a markup language or a programming language, and hence the work support system 1 can reduce the burden on the administrator.

### Modification Example 2

For example, as described somewhat in the at least one embodiment, the rule may be defined for each organization that is an example of the tenant. In Modification Example 2, a case in which the tenant is an organization is taken as an example. In Modification Example 2, the "tenant" as used in the at least one embodiment can be replaced as "organization." The organization may be any organization, such as a company or a government agency.

The function information acquisition module 101 in Modification Example 2 acquires the function information on a work support function created for each organization that uses the work support system 1. For example, the data storage unit 100 has a storage area for each of a plurality of organizations. The storage area for a certain organization stores the function information on a work support function created by users of the certain organization. The function information acquisition module 101 acquires the function information on the certain organization from the storage area for the certain organization.

The rule information acquisition module 102 in Modification Example 2 acquires the rule information defined for each organization. An administrator of a certain organization uploads the rule information defining the rule for the certain organization to the server 10. For example, the rule information indicating the rule defined by the administrator of the certain organization is stored in the storage area of the data storage unit 100 for the certain organization. The rule information acquisition module 102 acquires the rule information on the certain organization from the storage area for the certain organization.

The estimation module 103 in Modification Example 2 causes the AI to estimate, for each organization, whether or not the work support function of that organization complies with the rule of that organization based on the function information on that organization and the rule information on that organization. For example, the estimation module 103 inputs the function information on a certain organization and the rule information on the certain organization to the AI, and acquires an estimation result, which is output from the AI, and indicates whether or not the work support function of the certain organization complies with the rule of the certain organization. The estimation result output module 104 in Modification Example 2 outputs, for each organization, the estimation result obtained by the AI. For example, the estimation result output module 104 outputs, for each organization, the estimation result obtained by the AI by transmitting data indicating the estimation result obtained by the AI to the user terminal 20 of a user of the certain organization.

The work support system 1 according to Modification Example 2 acquires the function information on a work support function created for each organization. The work support system 1 acquires the rule information defined for each organization. The work support system 1 causes the AI to estimate, for each organization, whether or not the work support function of that organization complies with the rule of that organization, based on the function information of that organization and the rule information on that organization. The work support system 1 outputs, for each organization, the estimation result obtained by the AI. As a result, the work support system 1 can appropriately determine whether or not the work support function of each organization complies with the rule.

### Modification Example 3

For example, the content to be estimated by the AI is not limited to the example of the at least one embodiment. In Modification Example 3, a case in which the estimation module 103 causes the AI to estimate a handling method to be followed when the work support function does not comply with the rule is taken as an example. The handling method is a method for allowing the work support function that does not comply with the rule to comply with the rule. For example, the handling method may be a method of changing a setting for allowing the work support function to comply with the rule, a method of registering the registered-in-function information for allowing the work support function to comply with the rule, or another method.

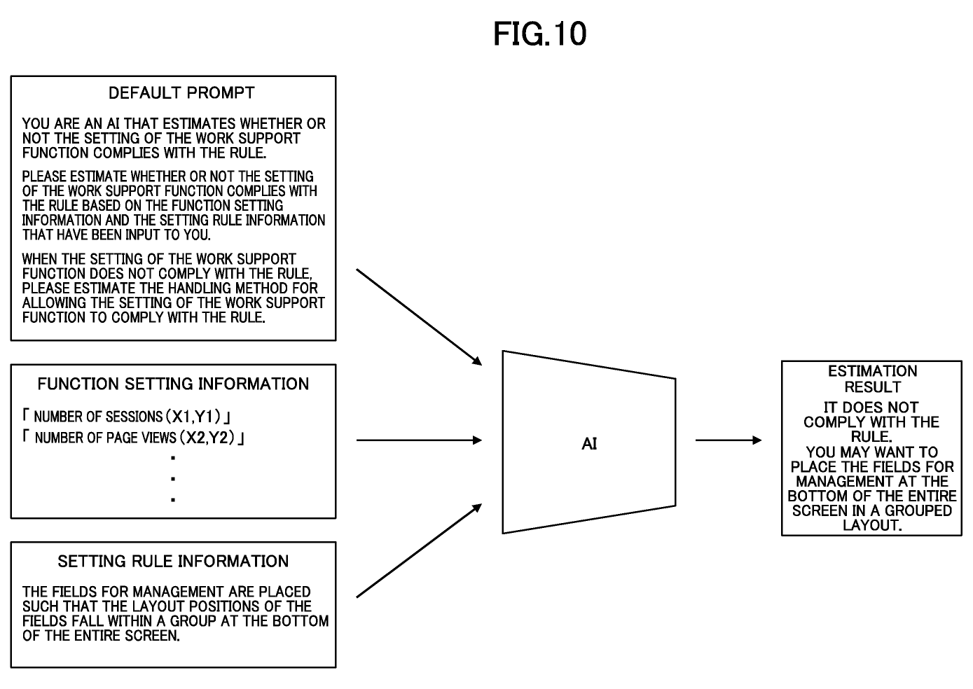

FIG. 10 is a diagram for illustrating an example of AI inputs and an AI output in Modification Example 3. In Modification Example 3, as in the at least one embodiment, a case in which the AI is managed by an external system is taken as an example, but the AI may be managed by the work support system 1. The default prompt in Modification Example 3 includes not only a wording that instructs the AI to estimate whether or not the work support function complies with the rule but also a wording that instructs the AI to estimate the handling method to be followed when the work support function does not comply with the rule. The wording may include any wording that means that the handling method is to be estimated. In the example of FIG. 10, the default prompt indicates text such as "When the setting of the work support function does not comply with the rule, please estimate the handling method for allowing the setting of the work support function to comply with the rule." in addition to the default prompt described in the at least one embodiment.

For example, as in FIG. 10, the estimation module 103 inputs the default prompt, the function setting information, and the setting rule information to the AI as the input information. The function setting information and the setting rule information may be embedded in the default prompt. In the at least one embodiment, an external system manages the AI, and hence the estimation module 103 inputs the default prompt, the function setting information, and the setting rule information to the AI by transmitting those pieces of information to the external system. When the external system acquires the default prompt, the function setting information, and the setting rule information from the server 10, the external system may input those pieces of information as the input information to the AI stored in the external system. When the actual data of the AI is stored in the data storage unit 100, the estimation module 103 may input the default prompt, the function setting information, and the setting rule information to the AI stored in the data storage unit 100 without communicating to/from an external computer.

For example, the AI calculates an embedded representation of the default prompt, the function setting information, and the setting rule information that have been input to the AI based on parameters adjusted by pre-training. The AI may divide the default prompt, the function setting information, and the setting rule information into units called tokens, and calculate an embedded representation of each token. When the AI includes a plurality of intermediate layers, the AI may repeatedly calculate the embedded representation based on each individual intermediate layer. The AI generates and outputs an estimation result corresponding to the embedded representation and a handling method to be followed when the work support function does not comply with the rule. When the default prompt, the function setting information, and the setting rule information are divided into tokens, the AI generates and outputs an estimation result corresponding to a sequence of the embedded representations of the individual tokens and a handling method therefor.

In the example of FIG. 10, the function setting information registered in the app does not comply with the rule, and hence the AI outputs the handling method therefor. For example, when the layout of the input form of the app does not satisfy the rule, the AI outputs, as the handling method, such a layout of the input form as to satisfy the rule. When the AI estimates that a screen layout of the app to be estimated is not consistent with screen layouts of other apps and does not comply with the rule, the AI outputs, as the handling method, such a screen layout as to achieve consistency. This series of processing steps is implemented by the calculation of the embedded representation described above. The estimation module 103 acquires the estimation result and the handling method that have been output from the AI. The processing in which the estimation module 103 acquires the output from the AI may be similar to that of the at least one embodiment. The estimation result output module 104 in Modification Example 3 outputs the estimation result of the handling method obtained by the AI. The estimation result output module 104 differs from the at least one embodiment in that the estimation result of the handling method is output, but the method itself of outputting the estimation result may be similar to that of the at least one embodiment.

The work support system 1 in Modification Example 3 causes the AI to estimate the handling method to be followed when the work support function does not comply with the rule. The work support system 1 outputs the estimation result of the handling method obtained by the AI. As a result, the user can know the handling method for allowing the work support function to comply with the rule, and hence the work support system 1 can increase convenience of the user. For example, the user or the administrator refers to the estimation result obtained by the AI to perform the setting change of the work support function in order to allow the work support function to comply with the rule. The work support system 1 may execute the setting change of the work support function based on the estimation result obtained by the AI.

### Modification Example 4

For example, in Modification Example 3, the case in which the AI is caused to estimate the handling method to be followed when the work support function does not comply with the rule has been taken as an example, but the AI may be caused to estimate other content. In Modification Example 4, a case in which the estimation module 103 causes the AI to estimate a risk to be incurred when the work support function does not comply with the rule is taken as an example. The risk can also be said to be a disadvantage or a malfunction that occurs when the work support function does not comply with the rule, or a possibility or a degree of impact of the occurrence of a disadvantage or a malfunction.

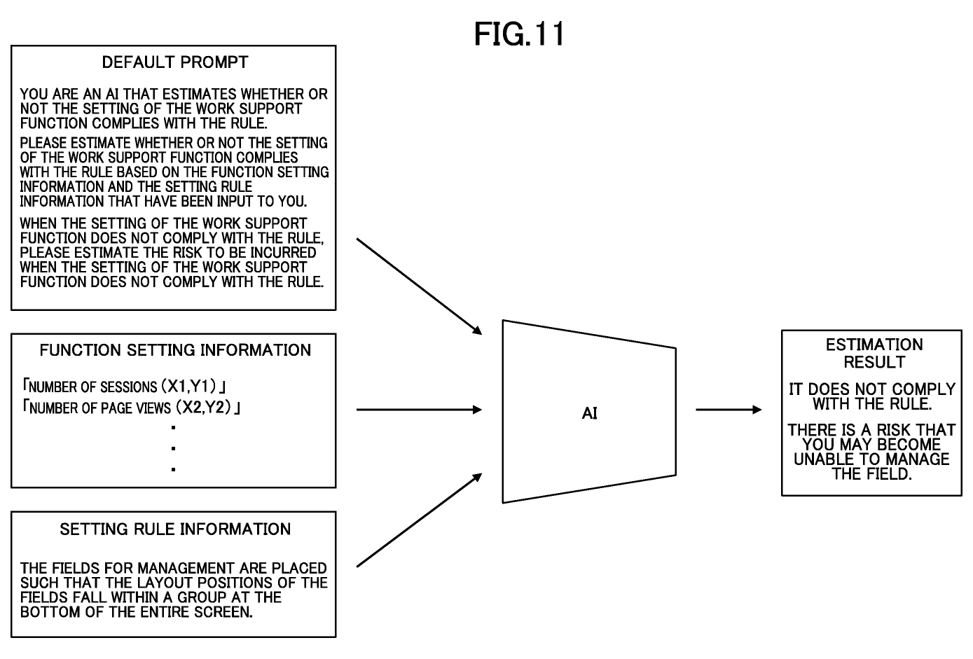

FIG. 11 is a diagram for illustrating an example of AI inputs and an AI output in Modification Example 4. In Modification Example 4, as in the at least one embodiment, a case in which the AI is managed by an external system is taken as an example, but the AI may be managed by the work support system 1. The default prompt in Modification Example 4 includes not only a wording that instructs the AI to estimate whether or not the work support function complies with the rule but also a wording that instructs the AI to estimate the risk to be incurred when the work support function does not comply with the rule. The wording may include any wording that means that the risk is to be estimated. In the example of FIG. 11, the default prompt indicates text such as "When the setting of the work support function does not comply with the rule, please estimate the risk to be incurred when the setting of the work support function does not comply with the rule." in addition to the default prompt described in the at least one embodiment.

For example, as in FIG. 11, the estimation module 103 inputs the default prompt, the function setting information, and the setting rule information to the AI as the input information. The function setting information and the setting rule information may be embedded in the default prompt. In the at least one embodiment, an external system manages the AI, and hence the estimation module 103 inputs the default prompt, the function setting information, and the setting rule information to the AI by transmitting those pieces of information to the external system. When the external system acquires the default prompt, the function setting information, and the setting rule information from the server 10, the external system may input those pieces of information as the input information to the AI stored in the external system. When the actual data of the AI is stored in the data storage unit 100, the estimation module 103 may input the default prompt, the function setting information, and the setting rule information to the AI stored in the data storage unit 100 without communicating to/from an external computer.

For example, the AI calculates an embedded representation of the default prompt, the function setting information, and the setting rule information that have been input to the AI based on parameters adjusted by pre-training. The AI may divide the default prompt, the function setting information, and the setting rule information into units called tokens, and calculate an embedded representation of each token. When the AI includes a plurality of intermediate layers, the AI may repeatedly calculate the embedded representation based on each individual intermediate layer. The AI generates and outputs an estimation result corresponding to the embedded representation and a risk to be incurred when the work support function does not comply with the rule. When the default prompt, the function setting information, and the setting rule information are divided into tokens, the AI generates and outputs an estimation result corresponding to a sequence of the embedded representations of the individual tokens and a risk therefor.

In the example of FIG. 11, the function setting information registered in the app does not comply with the rule, and hence the AI outputs the risk therefor. For example, when the layout of the input form of the app does not satisfy the rule, the AI outputs, as the risk, a risk that the user may become unable to manage the field. The risk may be scored and output. This series of processing steps is implemented by the calculation of the embedded representation described above. The estimation module 103 acquires the estimation result and the risk that have been output from the AI. The processing in which the estimation module 103 acquires the output from the AI may be similar to that of the at least one embodiment. The estimation result output module 104 in Modification Example 4 outputs the estimation result of the risk obtained by the AI. The estimation result output module 104 differs from the at least one embodiment in that the estimation result of the risk is output, but the method itself of outputting the risk may be similar to that of the at least one embodiment.

The work support system 1 in Modification Example 4 causes the AI to estimate the risk to be incurred when the work support function does not comply with the rule. The work support system 1 outputs the estimation result of the risk obtained by the AI. As a result, the user can know the risk to be incurred when the work support function does not comply with the rule, and hence the work support system 1 can increase convenience of the user.

### Modification Example 5

For example, in the at least one embodiment, the case in which the administrator of the tenant creates a rule has been taken as an example, but the rule may be generated by an AI that estimates compliance with the rule or another AI. The another AI is an AI different from the AI that estimates the compliance with the rule. The another AI may be an AI of the same type as, or may be an AI of a different type from, that of the AI that estimates the compliance with the rule. The another AI may be any model such as the large language model described above. The AI that estimates the compliance with the rule is simply hereinafter referred to as "AI." The another AI may be obtained by replacing, as "another AI," the "AI" in the description of the specific example of the AI described in the at least one embodiment (for example, the specific example such as the large language model or the like).

The work support system 1 according to Modification Example 5 further includes the rule information generation module 105. The rule information generation module 105 causes the AI or another AI to generate rule information based on each of a plurality of work support functions. The rule information generation module 105 causes the AI or another AI to generate rule information based on the function information on each of the plurality of work support functions. For example, the rule information generation module 105 may cause the AI or another AI to estimate a commonality in the function information among the respective plurality of work support functions, and cause the AI or another AI to generate rule information based on an estimation result of the commonality. The rule information generation module 105 may cause the AI or another AI to generate rule information based on a situation at a time of error occurrence in each of the plurality of work support functions in which an error has occurred.

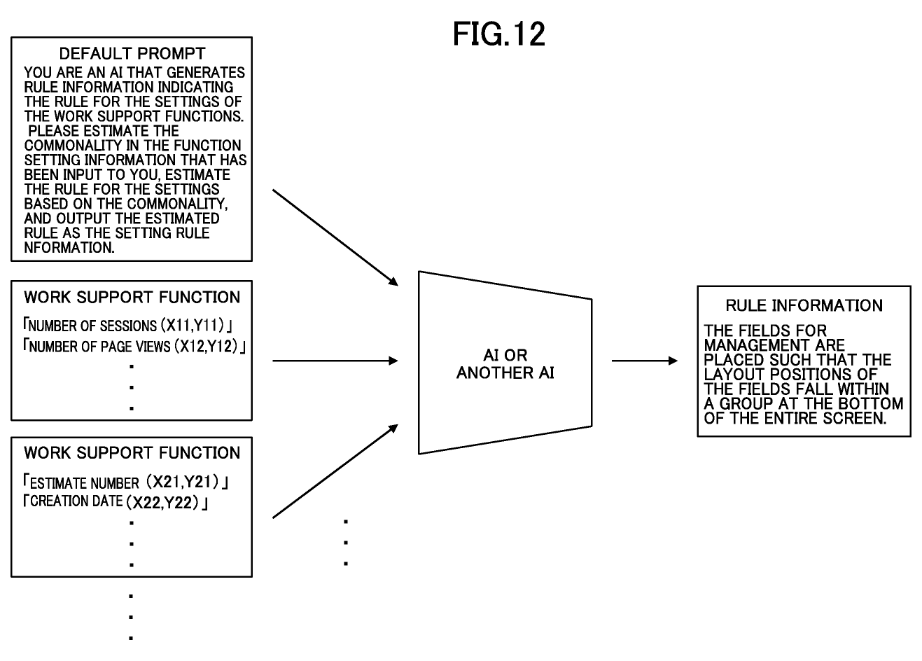

FIG. 12 is a diagram for illustrating an example of inputs to and an output from an AI or another AI that generates rule information in Modification Example 5. In the example of FIG. 12, the default prompt is input to the AI or another AI. The default prompt in Modification Example 5 indicates an instruction to generate rule information instead of an instruction to estimate the compliance with the rule. In Modification Example 5, a case in which the rule information generation module 105 causes the AI or another AI to generate setting rule information based on the function setting information on each of a plurality of work support functions is taken as an example. The default prompt may include a wording indicating that the AI is to estimate a commonality among the plurality of work support functions and to generate a rule based on the commonality. For example, the default prompt may include a wording indicating that the AI is to estimate consistency among the plurality of work support functions and to generate a rule based on the consistency.

For example, the default prompt may indicate text such as "You are an AI that generates rule information indicating the rule for the settings of the work support functions. Please estimate the commonality in the function setting information that has been input to you, estimate the rule for the settings based on the commonality, and output the estimated rule as the setting rule information." In this default prompt, the portion "You are an AI that generates rule information indicating the rule for the settings of the work support functions." indicates the role of the AI. The next portion "Please estimate the commonality in the function setting information that has been input to you, estimate the rule for the settings based on the commonality, and output the estimated rule as the setting rule information." indicates the specific content of the input information and the specific content to be estimated by the AI.

The default prompt may be any wording. The default prompt is not limited to the wording of FIG. 12. The default prompt may include any wording that means that the rule information is to be generated based on each of the plurality of work support functions. In Modification Example 5, a case in which the function setting information is acquired as the function information and the setting rule information is generated as the rule information is taken as an example, and hence the default prompt may include any wording that means that the setting rule information is to be generated based on the function setting information. The default prompt may be any one of various wordings that can be adopted by a person skilled in the art in the field of AI as a prompt required for generation of the setting rule information in the state of the art at the time of filing.

For example, as in FIG. 12, the rule information generation module 105 inputs the default prompt and the function setting information on each of the plurality of work support functions as the input information to the AI or another AI. The function setting information and the setting rule information may be embedded in the default prompt. In the at least one embodiment, an external system manages the AI or another AI, and hence the rule information generation module 105 inputs the default prompt and the function setting information on each of the plurality of work support functions to the AI or another AI by transmitting those pieces of information to the external system. When the external system acquires the default prompt and the function setting information on each of the plurality of work support functions from the server 10, the external system may input those pieces of information as the input information to the AI or another AI stored in the external system. When the actual data of the AI or another AI is stored in the data storage unit 100, the rule information generation module 105 may input the default prompt and the function setting information on each of the plurality of work support functions to the AI or another AI stored in the data storage unit 100 without communicating to/from an external computer.

For example, the AI or another AI calculates an embedded representation of the default prompt and the function setting information on each of the plurality of work support functions that have been input to the AI or another AI based on parameters adjusted by pre-training. The AI or another AI may divide the default prompt and the function setting information on each of the plurality of work support functions into units called tokens, and calculate an embedded representation of each token. When the AI or another AI includes a plurality of intermediate layers, the AI or another AI may repeatedly calculate the embedded representation based on each individual intermediate layer. The AI or another AI generates and outputs an estimation result corresponding to the embedded representation. When the default prompt and the function setting information on each of the plurality of work support functions are divided into tokens, the AI or another AI generates and outputs an estimation result corresponding to a sequence of the embedded representations of the individual tokens. Internal processing of the AI or another AI is not limited to the example of the at least one embodiment. The internal processing of the AI or another AI may be processing similar to that of a publicly-known AI or another AI.

In the example of FIG. 12, the AI or another AI estimates the commonality among the respective plurality of work support functions, estimates the rule corresponding to the commonality, and outputs the setting rule information. This series of processing steps is implemented by the calculation of the embedded representation described above. The rule information generation module 105 acquires the setting rule information output from the AI or another AI. In the at least one embodiment, an external system manages the AI or another AI, and hence the external system transmits the setting rule information to the server 10. The rule information generation module 105 acquires the setting rule information from the external system. When the actual data of the AI or another AI is stored in the data storage unit 100, the rule information generation module 105 may acquire the setting rule information without communicating to/from an external computer.

The AI or another AI is not required to be a general-purpose AI or another AI specialized for a specific task, and may be an AI or another AI specialized for the task of generating rule information. In this case, training data indicating a relationship between the function information such as function setting information for training and the rule information for training is assumed to have been learned by the AI or another AI. The learning of the training data may be executed by the server 10, or may be executed by another computer. The AI or another AI is trained so that, when the function information (for example, the function setting information) for training, which is indicated by the training data, is input to the AI or another AI, the rule information (for example, the setting rule information) for training, which is indicated by the training data, is output from the AI or another AI.

Further, the AI or another AI may be trained by a publicly-known learning method used in a machine learning method. For example, the training data may be learned by the AI or another AI by the error backpropagation method or the gradient descent method. When the AI or another AI is specialized for a specific task, the AI or another AI can generate rule information even without particularly having a prompt input thereto, and hence the rule information generation module 105 may input the input information to the AI or another AI without inputting a prompt to the AI or another AI. In this way, a mode in which the rule information is generated without the input of a prompt is also within the scope of the present disclosure.

The rule information acquisition module 102 in Modification Example 5 acquires the rule information generated by the AI or another AI. For example, the rule information generated by the rule information generation module 105 is recorded in the data storage unit 100. The rule information acquisition module 102 acquires the rule information generated by the rule information generation module 105 from the data storage unit 100. The rule information acquisition module 102 acquires the rule information generated by the rule information generation module 105 from another computer other than the server 10 or an information storage medium. The processing steps after the acquisition of the rule information may be the same as those of the at least one embodiment or Modification Examples 1 to 4.

The work support system 1 according to Modification Example 5 causes the AI or another AI to generate rule information based on each of the plurality of work support functions. The work support system 1 acquires the rule information generated by the AI or another AI. As a result, the user is no longer required to create rule information, and hence the work support system 1 can increase the convenience of the user.

The work support system 1 may include the rule information generation module 105 without including the function information acquisition module 101, the rule information acquisition module 102, the estimation module 103, and the estimation result output module 104. That is, the work support system 1 may only have a function of generating rule information based on a plurality of work support functions without including a function of causing the AI to estimate whether or not the work support function complies with the rule. In this case, the work support system 1 may record the rule information generated by the rule information generation module 105 in the data storage unit 100, and provide the rule information to the user or the administrator. The user or the administrator may define a rule by referring to the rule information generated by the rule information generation module 105, or may apply the rule indicated by the rule information as it is.

For example, when the work support system 1 includes the rule information generation module 105 without including the function information acquisition module 101, the rule information acquisition module 102, the estimation module 103, and the estimation result output module 104, the work support system 1 can address the problem of increasing the convenience of the user. The problem in the present disclosure is not limited to the problem described in the "SUMMARY OF THE INVENTION" section. A mode of addressing the problem of increasing the convenience of the user without addressing the problem described in the "SUMMARY OF THE INVENTION" section of the present disclosure is also within the scope of the present disclosure.

### Modification Example 6

For example, when the user finishes creating a work support function, the work support function is released to the work support system 1. With the app as an example, when the user finishes designating the setting content on the app creation screen SC3, the app is released to the work support system 1. The respective processing steps of the function information acquisition module 101, the rule information acquisition module 102, the estimation module 103, and the estimation result output module 104 may be executed before the work support function is released to the work support system. For example, when the user performs, on the app creation screen SC3, a predetermined operation to cause the AI to execute the estimation, the respective processing steps of the function information acquisition module 101, the rule information acquisition module 102, the estimation module 103, and the estimation result output module 104 may be executed.

The work support system 1 according to Modification Example 6 includes the release module 106. After the estimation result is output to the user, the release module 106 releases the work support function based on an operation of the user. After the estimation result is output to the user, the user may change the setting of the work support function. For example, when the function setting information designated by the user does not comply with the rule, the user changes the function setting information so that the function setting information complies with the rule. When the user performs an operation to release the work support function, the release module 106 releases the work support function by recording the data of the work support function in the data storage unit 100. The release module 106 may release the work support function by changing a value of information indicating validity of the work support function. In this case, the work support system 1 provides a valid work support function to the user.

In Modification Example 6, the respective processing steps of the function information acquisition module 101, the rule information acquisition module 102, the estimation module 103, and the estimation result output module 104 are executed before the work support function is released to the work support system 1. After the estimation result is output to the user, the work support system 1 releases the work support function based on an operation of the user. As a result, the user can release the work support function after examining whether or not the work support function complies with the rule.

### Other Modification Examples

For example, two or more of Modification Examples 1 to 6 may be combined.

For example, the functions described as being implemented by the server 10 may be implemented by the user terminal 20. In this case, it suffices that the functions are implemented by a browser script or an application installed on the user terminal 20. For example, the respective functions may be distributed to a plurality of computers, or may be implemented by a single computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A work support system, comprising at least one processor configured to:
acquire function information relating to a work support function, which supports work, and is created by a user;
acquire rule information relating to a rule for the work support function;
cause an artificial intelligence (AI) to estimate whether the work support function complies with the rule based on the function information and the rule information; and
output an estimation result obtained by the AI.

2. The work support system according to claim 1, wherein the at least one processor is configured to:
acquire, as the function information, function setting information relating to a setting, which relates to the work support function, and is designated by the user;
acquire, as the rule information, setting rule information relating to a rule for the setting; and
cause the AI to estimate whether the setting complies with the rule based on the function setting information and the setting rule information.

3. The work support system according to claim 1, wherein the at least one processor is configured to:
acquire, as the function information, registered-in-function information, which is information registered as actual data in the work support function;
acquire, as the rule information, registration rule information relating to a rule for the registered-in-function information; and
cause the AI to estimate whether the registered-in-function information complies with the rule based on the registered-in-function information and the registration rule information.

4. The work support system according to claim 1, wherein the at least one processor is configured to:
acquire the function information on the work support function created for each organization that uses the work support system;
acquire the rule information defined for the each organization;
cause the AI to estimate, for the each organization, whether the work support function of the each organization complies with the rule of the each organization based on the function information on the each organization and the rule information on the each organization; and
output, for the each organization, the estimation result obtained by the AI.

5. The work support system according to claim 1, wherein the at least one processor is configured to:
cause the AI to estimate a handling method to be followed when the work support function does not comply with the rule; and
output an estimation result of the handling method obtained by the AI.

6. The work support system according to claim 1, wherein the at least one processor is configured to:
cause the AI to estimate a risk to be incurred when the work support function does not comply with the rule; and
output an estimation result of the risk obtained by the AI.

7. The work support system according to claim 1, wherein the at least one processor is configured to:
cause one of the AI or another AI to generate the rule information based on each of a plurality of the work support functions; and
acquire the rule information generated by one of the AI or the another AI.

8. The work support system according to claim 1,
wherein processing of the at least one processor is executed before the work support function is released to the work support system, and
wherein the at least one processor is configured to release the work support function based on an operation of the user after the estimation result is output to the user.

9. A work support method, comprising:
acquiring function information relating to a work support function, which supports work, and is created by a user;
acquiring rule information relating to a rule for the work support function;
causing an artificial intelligence (AI) to estimate whether the work support function complies with the rule based on the function information and the rule information; and
outputting an estimation result obtained by the AI.

10. A non-transitory information storage medium having stored thereon a program for causing a computer to:
acquire function information relating to a work support function, which supports work, and is created by a user;
acquire rule information relating to a rule for the work support function;
cause an artificial intelligence (AI) to estimate whether the work support function complies with the rule based on the function information and the rule information; and
output an estimation result obtained by the AI.
